(19) United States
(12) Patent Application Publication
(10) Pub. No.: US 2011/0061819 A1
(43) Pub. Date: Mar. 17, 2011

(54) ROOM PRIVACY TRACK SYSTEM

(75) Inventor: Leonard Elinson, Rancho Dominguez, CA (US)

(73) Assignee: MARIAK INDUSTRIES, INC., Rancho Dominguez, CA (US)

(21) Appl. No.: 12/561,087

(22) Filed: Sep. 16, 2009

(51) Int. Cl. E05D 15/06

(52) U.S. Cl. 160/196.1

(57) ABSTRACT

A track system includes a track having a central vertical member with opposing vertical surfaces. A pair of lower horizontal rails extend from the vertical member and do not block the vertical surfaces. Flexible carriers are individually removable from the track. Each carrier includes a flexible frame coupled to a pair of wheels configured to roll on the rails. The carriers may each include a hanger or other connector for supporting privacy structures such as curtains, drapes, window treatments, and dividers. The tracks may be bent and coupled end to end to form a complete assembly for facilitating privacy in a room.

### FIELD OF THE INVENTION

The present invention is directed to a track system for room dividers, hospital cubicles, curtains, window treatments, and other such privacy applications.

### BACKGROUND OF THE INVENTION

### Description of Prior Art and Related Information

Curtain tracks are commonly employed in hospitals, offices, and rooms where privacy is desired for a particular space. In the prior art, an entire set of rigid hangers must be loaded at one of the two ends of each track. If a particular hanger is broken, the entire set of hangers must be removed from one of the ends of the track in order to access the broken hanger. In hospitals where staff members are often rushing to deal with critical health issues, there is a shortage of time and availability in dealing with a tedious and time-consuming task of fixing a curtain track.

Rails on conventional tracks also include external vertical walls in order to retain the wheels on the hangers. Such external vertical walls block access to the center portion of the track, thereby preventing the track from being cleaned. This can lead to unsanitary conditions which are particularly undesirable in a hospital setting.

Rigid vertical walls on conventional tracks not only add to the weight and expense in manufacturing, but also makes it more difficult to bend the track when a curvature is required.

### SUMMARY OF THE INVENTION

The present invention provides structures and methods which overcome the deficiencies in the prior art.

In one aspect, a track system is provided. The system comprises a track and a plurality of carriers, each of which is individually removable from the track. The track includes a first vertical surface and a second vertical surface, a first lower horizontal rail extending from the first vertical surface, and a second lower horizontal rail extending from the second vertical surface. Substantially all of the first and second vertical surfaces are accessible for cleaning.

Each carrier comprises a flexible frame and a pair of wheels configured to roll on the first and second rails. The flexible frame comprises a pair of arms that extend upwardly and surround the first and second lower horizontal rail. A base is coupled to the pair of arms. The carrier defines a space between the wheels and the base that is large enough to slidingly receive the horizontal rails.

The track may be metallic. By including less metal than conventional tracks, the metallic track may be more easily curved to provide a track assembly with bends as desired to facilitate privacy. An antimicrobial coating may disposed on at least a portion of the track.

In a further aspect, a track system comprises a first track connected to a second track, each of which may be metallic. The first track comprises a first vertical spine and a first pair of lower horizontal rails. The second track is curved and connected to the first metallic track. The second metallic track comprises a second vertical spine and a second pair of lower horizontal rails. A first carrier is removably coupled to the first metallic track. A second carrier is removably coupled to the second metallic track. An antimicrobial coating may be disposed on the first metallic track and the second metallic track.

The first carrier may be interchangeable with the second metallic track. Each carrier comprises a flexible frame and a pair of wheels. The flexible frame comprises a pair of arms that extend upwardly and surround the first pair of lower horizontal rails. The frame comprises a base coupled to the pair of arms. The carrier defines a space between the wheels and the base that is large enough to slidingly receive the horizontal rails.

In a further aspect, a track system comprises a metallic track comprising a first vertical surface, a second vertical surface, and a pair of horizontal rails. Each of the vertical surfaces are substantially accessible. Individually removable carriers are coupled to the track. Each carrier comprises a flexible frame and a pair of wheels configured to roll on the rails. The track may be metallic and curved. An antimicrobial coating may be applied on the metallic track. The flexible frame of the carrier comprises a pair of arms that extend upwardly and surround the pair of horizontal rails. The frame comprises a base coupled to the pair of arms. The carrier defines a space between the wheels and the base that is large enough to slidingly receive the pair of horizontal rails.

In a further aspect, a track system includes a track having a central vertical member with opposing vertical surfaces. A pair of lower horizontal rails extend from the vertical member and do not block the vertical surfaces. Flexible carriers are individually removable from the track. Each carrier includes a flexible frame coupled to a pair of wheels configured to roll on the rails. The carriers may each include a hanger or other connector for supporting privacy structures such as curtains, drapes, window treatments, and dividers. The tracks may be bent and coupled end to end to form a complete assembly for facilitating privacy in a room.

### BRIEF DESCRIPTION OF THE DRAWINGS

FIG. 1 is an exploded view of a first preferred embodiment of a track system;

FIG. 2 is a front elevation view of a preferred carrier;

FIG. 3 is a view of the preferred track system illustrating carriers being individually removed from and assembled onto the track;

FIG. 4 is a perspective view of a preferred track system operating as a room divider; and

FIG. 5 is a diagram of a preferred method of facilitating privacy in a room.

### DETAILED DESCRIPTION OF THE PREFERRED EMBODIMENTS

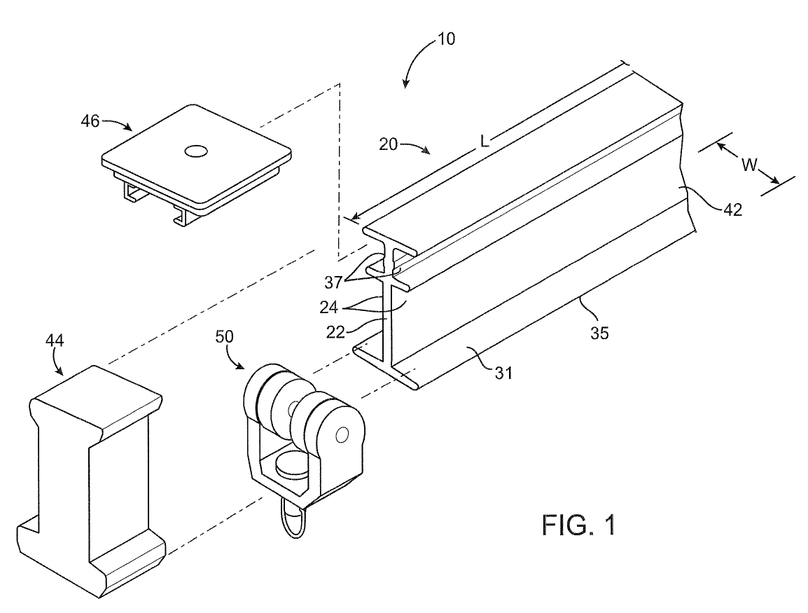

A first preferred embodiment of a track system is illustrated in FIG. 1 and designated generally by the reference numeral 10. The system 10 comprises one or more tracks 20 preferably composed of metal. Each track 20 comprises a central vertical member, or spine, 22 having a pair of opposing vertical surfaces 24. A pair of lower horizontal rails 31 extend outwardly, or laterally, from the medial vertical member 22. Each track 20 defines a length “L” and a width “W.”

Both rails 31 preferably extend horizontally and laterally from the vertical surfaces 24 to an outer, or lateral, edge 35. In the preferred embodiment, each rail 31 omits any outer vertical walls which would block access to the vertical surfaces 24 of the central vertical member 22. The horizontal rails 31 preferably comprise horizontal surfaces which expose the vertical surfaces 24 of the spine 22, thereby making them substantially accessible for cleaning, for example. A pair of upper grooves 37 are formed along the length of the track 20 for receiving brackets 39 and other connectors for coupling the system 10 to a ceiling or building structure. From an end view, the preferred track 20 comprises an “I” profile as illustrated in FIG. 1.

An antimicrobial coating 42 may be disposed on the track 20 which would be particularly desirable when the system 10 is used as a hospital room divider, for example. In particular, the coating 42 is preferably applied to the vertical surfaces 24 and the horizontal rails 31. As an example and not by way of limitation, the coating 42 may inhibit the growth of fungi, algae and bacteria. End caps 44 may be coupled to an open end of an assembly of tracks 20. Brackets 46 may be used to couple the tracks 20 to a structure above, such as a ceiling.

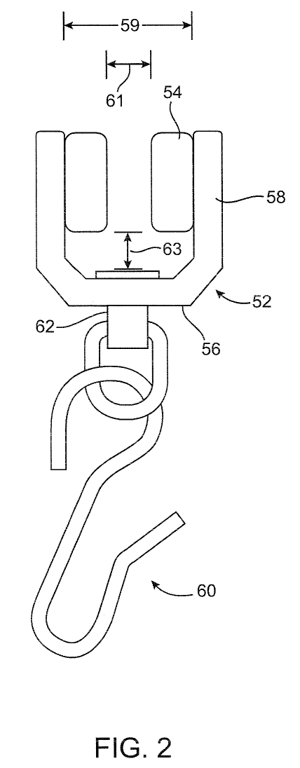

The system 10 also comprises carriers 50 coupled to the track 20 and configured for supporting curtains, drapes, dividers, and all types of window treatments, etc. In the preferred embodiment, each carrier 50 is individually removable from the track 20. In FIG. 2, each carrier 50 preferably comprises a flexible frame 52 coupled to a pair of wheels 54. As an example, the flexible frame 52 may be composed of a bendable plastic material such as polyoxymethylene (POM), high density polyethylene (HDPE) and thermoplastic polyurethane, just to name a few examples. The flexible frame 52 preferably comprises a U-shaped structure having a horizontal base 56 and a pair of vertical arms 58 extending upwardly from the base 56. In the default unbent position, the pair of arms 58 define an internal width 59 that is greater than the width W of the horizontal rails 31 shown in FIG. 1, while the pair of wheels 54 define an internal space, or width, therebetween 61 that is wider than the thickness of the spine 22 of the track 20. These features of the carrier, along with the space 63 between the bottom of the wheels 54 and the top of the base 56, facilitate smooth travel of the carrier 50 on the track 20. A hanger 60, or other such connector configured for hanging vertically oriented structures to facilitate privacy, is connected to (e.g., suspended from) a pivot member 62 which is coupled to the base 56.

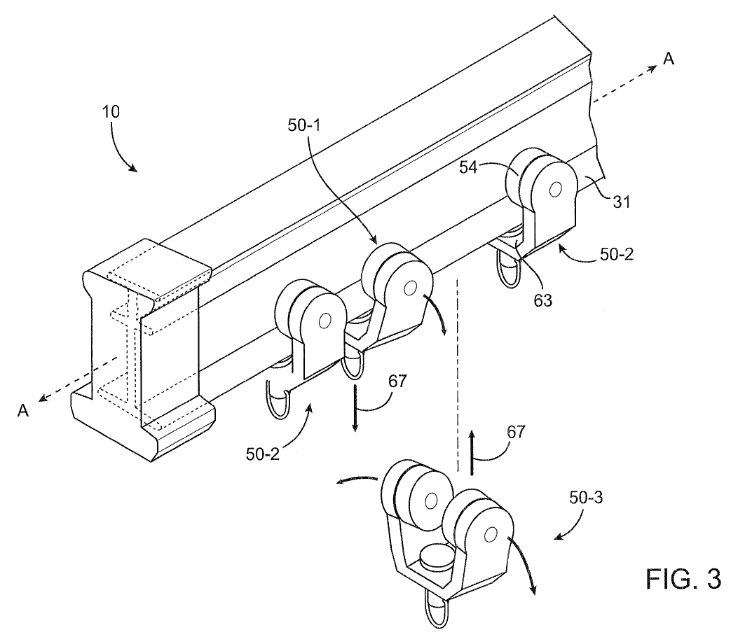

When assembled as shown in FIG. 3, the pair of wheels 54 are configured to roll freely on the horizontal rails 31 along the axis A while each carrier 50 remains secured to the track 20. Accordingly, referring to FIGS. 2 and 3, sufficient space 63 is provided between the bottom of the wheels 54 and the top of the base 56 to slidingly receive the horizontal rails 31 of the track 20. By omitting any outer vertical walls on the rails 31, the pair of arms 58 extending upwardly over the rail edge 35 and surround the rails 31. In effect, the base 56, pair of arms 58 and pair of wheels 54 of each carrier 50 collectively surround the pair of rails 31 when assembled.

Furthermore, by omitting any vertical retention structures on the rails 31, each carrier 50 may be individually removed from the track 20 by simply bending the flexible frame 52, namely, by bending the arms 58 away from each, to separate the wheels 54 from the track 20. Alternatively stated, each pair of wheels 54 on a carrier 50 may be independently and separately removed from and installed onto the track 20 without interfering with any other installed carrier 50.

In FIG. 3, it will be appreciated that making each carrier 50 individually removable adds greater flexibility to the system 10, particularly in removing, repairing or substituting a broken carrier, for example. Instead of having to remove all carriers from one end of a track in order to access a broken carrier in the prior art, the broken carrier 50-1 in the preferred embodiment can be removed directly and independently of the other carriers 50-2 which can remain assembled on the track 20. Thus, the broken carrier 50-1 in the preferred embodiment need not be rolled along the length of the track 20 to an end in order to be removed.

Furthermore, a new or substitute carrier 50-3 need not be inserted at one end of the track 20, but can simply be installed at the desired location between other already assembled carriers 50-2. The lack of prior art retention means in the preferred track 20, such as outer vertical walls, enables each carrier 50 in the preferred embodiment to be independently disengaged from the track 20 without requiring the removal of any other carriers 50. Alternatively stated, each carrier 50 in the preferred embodiment may be individually removed from, or installed onto, the track 20 in a direction 67 generally perpendicular to an axis “A” defined by the track 20.

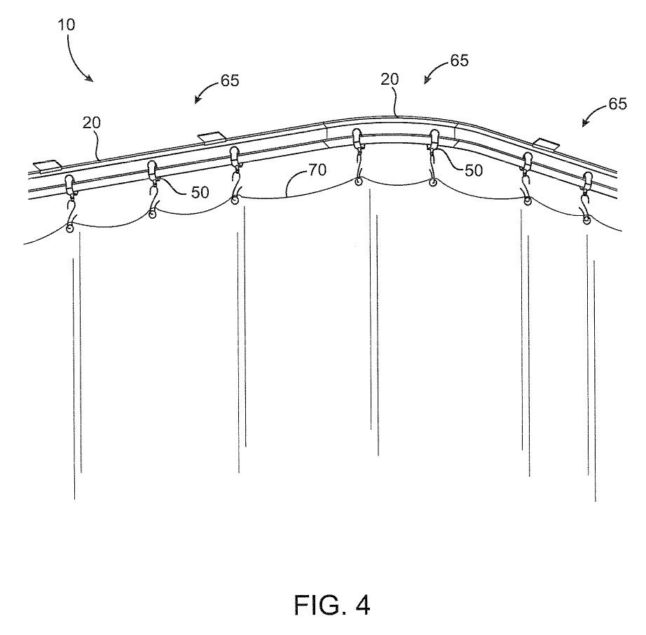

Each track 20 and corresponding set of assembled carriers 50 form a sub-assembly 65. In FIG. 4, the system 10 may comprise multiple sub-assemblies 65 coupled end to end to form a complete assembly, or boundary, for segregating a space, e.g., a section of a hospital room. Privacy structures 70, such as curtains, drapes, dividers, etc., are hung from the carriers 50 to facilitate privacy, such as dividing a section of a hospital room. By omitting outer vertical walls in the preferred tracks 20, each track 20 has less metal than those in the prior art, thereby making each track 20 more easily bendable. This is highly advantageous in forming curved tracks which are typically required in hospital and office room applications.

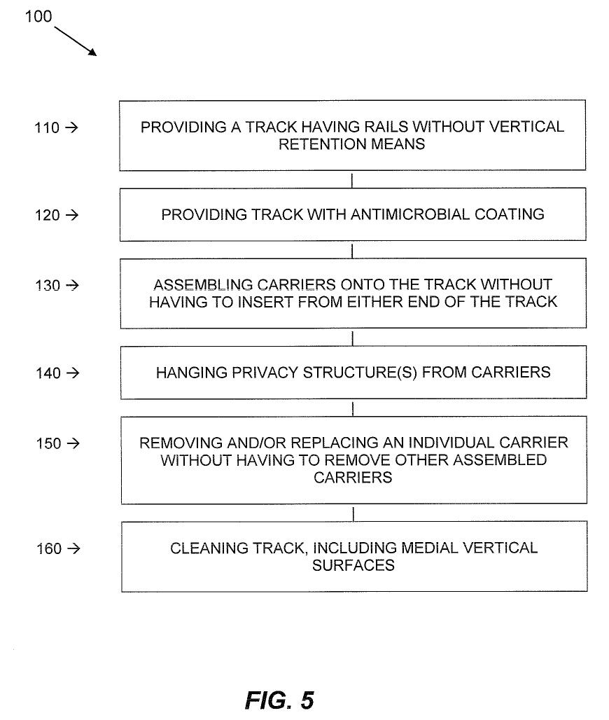

FIG. 5 illustrates a preferred method 100 of facilitating privacy in a room. The method 100 comprises the step 110 of providing a track, preferably composed metal, having rails without vertical retention means. Step 110 may also comprising bending the track to provide a curved metallic track. Step 120 comprises applying an antimicrobial coating on the track.

Step 130 comprises assembling carriers onto the track without having to insert from the carriers from either end of the track. Step 130 is made possible by the combination of providing the carriers with flexible frames and omitting any vertical retention walls on the track that would otherwise require each carrier to be inserted from one of the two ends of the track. Step 140 comprises hanging privacy structure(s) from the carriers.

If a particular carrier needs to be removed or replaced, step 150 comprises removing and/or replacing an individual carrier without having to remove other carriers already assembled onto the track. Step 150 thus comprises bending the flexible frame of the subject carrier and removing said carrier from the track without having to roll said carrier axially to one of the two ends of the track. Therefore, step 150 may comprise removing the subject carrier in a direction generally perpendicular to the length of the track. Step 150 also comprises assembling a new carrier onto the track.

Step 160 comprises cleaning the track, particularly wiping the substantially accessible vertical surfaces of the medial vertical member of the track. This step 160 is made possible by making the opposing vertical surfaces substantially accessible, such as by omitting carrier retention means (e.g., outer vertical walls) found in prior art tracks.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

1. A track system, comprising:
a track including a first vertical surface and a second vertical surface, a first lower horizontal rail extending from the first vertical surface, and a second lower horizontal rail extending from the second vertical surface; and
a plurality of carriers, each carrier being individually removable from the track,
wherein substantially all of the first and second vertical surfaces are accessible for cleaning.

2. The system of claim 1, wherein each carrier comprises a flexible frame and a pair of wheels configured to roll on the first and second rails.

3. The system of claim 2, wherein the flexible frame comprises a pair of arms that extend upwardly and surround the first and second lower horizontal rail.

4. The system of claim 3, wherein:
the frame comprises a base coupled to the pair of arms; and
the carrier defines a space between the wheels and the base that is large enough to slidingly receive the horizontal rails.

5. The system of claim 1, wherein the track is metallic.

6. The system of claim 3, wherein the track is curved.

7. The system of claim 1, further comprising an antimicrobial coating disposed on at least a portion of the track.

8. A track system, comprising:
a first track comprising a first vertical spine and a first pair of lower horizontal rails;
a second track being curved and connected to the first metallic track, the second metallic track comprising a second vertical spine and a second pair of lower horizontal rails;
a first carrier removably coupled to the metallic track; and
a second carrier removably coupled to the second metallic track.

9. The system of claim 8, further comprising an antimicrobial coating disposed on the first metallic track and the second metallic track.

10. The system of claim 8, wherein the first carrier is interchangeable with the second metallic track.

11. The system of claim 8, wherein each carrier comprises a flexible frame and a pair of wheels.

12. The system of claim 11, wherein the flexible frame comprises a pair of arms that extend upwardly and surround the first pair of lower horizontal rails.

13. The system of claim 12, wherein:
the frame comprises a base coupled to the pair of arms; and
the carrier defines a space between the wheels and the base that is large enough to slidingly receive the horizontal rails.

14. The system of claim 8, wherein the first track and the second track are each composed of metal.

15. A track system, comprising
a track comprising a first vertical surface, a second vertical surface, and a pair of horizontal rails, each of the vertical surfaces being substantially accessible; and
individually removable carriers coupled to the track, each carrier comprising a flexible frame and a pair of wheels configured to roll on the rails.

16. The system of claim 15, wherein the track metallic and curved.

17. The system of claim 15, further comprising an antimicrobial coating on the metallic track.

18. The system of claim 15, wherein the flexible frame comprises a pair of arms that extend upwardly and surround the pair of horizontal rails.

19. The system of claim 18, wherein:
the frame comprises a base coupled to the pair of arms; and
the carrier defines a space between the wheels and the base that is large enough to slidingly receive the pair of horizontal rails.
